(19) United States
(12) Patent Application Publication
(10) Pub. No.: US 2016/0303933 A1
(43) Pub. Date: Oct. 20, 2016

(54) SYSTEM, METHOD AND APPARATUS FOR INCREASING THE TRACTIVE EFFORT OF A VEHICLE

(71) Applicant: General Electric Company, Schenectady, NY (US)

(72) Inventor: DAVID NOWAKOWSKI, ERIE, PA (US)

(21) Appl. No.: 14/689,068

(22) Filed: Apr. 17, 2015

(51) Int. Cl. B60D 1/24; B61G 1/32

(52) U.S. Cl. CPC B60D 1/247; B61G 1/32

(57) ABSTRACT

A system includes a first vehicle, a second vehicle, and a load transferring apparatus intermediate the first vehicle and the second vehicle. The apparatus includes a substantially rigid linkage connecting the first vehicle to second vehicle which is configured to transmit a generally horizontal force between the first vehicle and the second vehicle, and a load transferring bar extending at a downward angle from the first vehicle to one of the second vehicle or the linkage. The load transferring bar is configured to selectively transfer weight from the first vehicle to the second vehicle.

### FIELD OF THE INVENTION

Embodiments of the invention relate generally to vehicles. Other embodiments relate to a system, method, and apparatus for increasing the tractive effort of a vehicle.

### BACKGROUND OF THE INVENTION

Locomotives and transit vehicles as well as other large traction vehicles are commonly powered by electric traction motors coupled in driving relationship to one or more axles of the vehicle. Locomotives and transit vehicles generally have at least four axle-wheel sets per vehicle with each axle-wheel set being connected via suitable gearing to the shaft of a separate electric motor commonly referred to as a traction motor. In the motoring mode of operation, the traction motors are supplied with electric current from a controllable source of electric power (e.g., an engine-driven traction alternator) and apply torque to the vehicle wheels which exert tangential force or tractive effort on the surface on which the vehicle is traveling (e.g., the parallel steel rails of a railroad track), thereby propelling the vehicle in a desired direction along the right of way.

Even push/pull carts or tugger units for moving wheeled vehicles and other wheeled devices from one location to another require substantial tractive effort to function as desired, especially when moving heavy loads that weigh in excess of the weight of the cart. In particular, moving extremely heavy wheeled loads from location to location with existing push/pull carts that weigh substantially less than the load being moved has proven to be challenging because of the tractive effort that is necessary.

The ability to produce high tractive efforts for use in heavy haul applications depends, in part, upon the available adhesion between the wheel and the surface upon which the wheel is in contact. As will be readily appreciated, adhesion is caused by friction, with maximum tangential force produced by a driving wheel before slipping given by:

Fmax=(coefficient of friction)·(weight on wheel)·(gravity)

As will be readily appreciated, the available adhesion and, therefore, the maximum tractive effort, may depend upon such factors as the presence of contaminants on the wheel, rail or other surface that the wheel rides upon, the shape (roundness) of the wheel, the shape of the rail, ambient temperature, and the normal force or weight imposed on the driving wheels of the vehicle, among others. Existing methods for increasing the tractive effort of rail and other vehicles such as push/pull carts has typically involved adding ballasts to the vehicle to increase the weight on the driving wheels, and depositing sand on the contact surface of the rail to increase the coefficient of friction thereof.

It may be desirable, however, to have a system, apparatus, and/or method for increasing the tractive effort of a wheeled vehicle that differ from those currently available.

### BRIEF DESCRIPTION OF THE INVENTION

In an embodiment, a system includes a first vehicle, a second vehicle, and a load transferring apparatus intermediate the first vehicle and the second vehicle. The apparatus includes a substantially rigid linkage connecting the first vehicle to second vehicle which is configured to transmit a generally horizontal force between the first vehicle and the second vehicle, and a load transferring bar extending at a downward angle from the first vehicle to one of the second vehicle or the linkage. The load transferring bar is configured to selectively transfer weight from the first vehicle to the second vehicle.

In another embodiment, an apparatus includes a substantially rigid linkage configured for coupling a first vehicle to a second vehicle, the linkage also being configured to transmit a generally horizontal force between the first vehicle and the second vehicle, and at least one load transferring bar configured for selective coupling with the first vehicle and one of the second vehicle or the linkage. The at least one load transferring bar is further configured, when coupled to the first vehicle and to the second vehicle or the linkage, to extend at a downward angle from the first vehicle to the second vehicle or the linkage and to selectively transfer weight from the first vehicle to the second vehicle.

In another embodiment, a method includes the steps of arranging a first vehicle adjacent to a second vehicle, the first vehicle and second vehicle being configured to travel along a surface, and coupling a first end of an extendable load transferring bar to the first vehicle at a first point, the first point defining a first height above the surface. The method further includes coupling a second end of the load transferring bar to the second vehicle at a second point. The second point defines a second height above the surface, the first height being greater than the second height. The method further includes extending the load transferring bar to transfer weight from the first vehicle to the second vehicle.

### BRIEF DESCRIPTION OF THE DRAWINGS

The present invention will be better understood from reading the following description of non-limiting embodiments, with reference to the attached drawings, wherein below:

FIG. 1 is a schematic view of a system for increasing the tractive effort of a vehicle, according to an embodiment of the invention.

FIG. 2 is an enlarged, side elevational of an apparatus for increasing the tractive effort of a vehicle, according to an embodiment of the invention.

FIG. 3 is an enlarged, top plan view of the apparatus of FIG. 2.

FIG. 4 is simplified, side elevational view of an apparatus for increasing the tractive effort of a vehicle, according to another embodiment.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. Although exemplary embodiments of the invention are described with respect to rail vehicles, embodiments of the invention may also be applicable for use with wheeled vehicles and apparatuses, generally, including, for example push/pull carts for moving heavy loads from one location to another.

As used herein, “selectively coupled” means that a component may be coupled to another component in one mode of operation, and decoupled with the another component in another mode of operation. As used herein “vehicle” means a machine used for transporting people or goods both on land, such as a car, truck, cart, OHV, mining vehicle, etc., and in other media, e.g., water. These include, but are not limited, to vehicles powered by combustion engines, electric motors, or hybrid configurations. The vehicle may be non-powered.

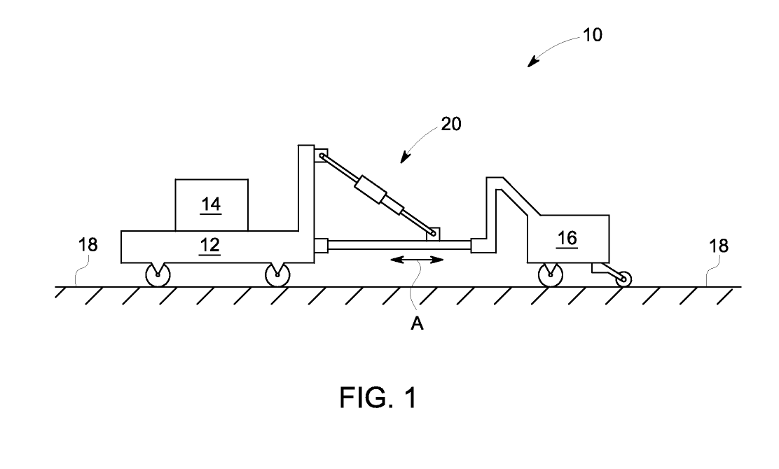

With reference to FIG. 1, a system 10 for increasing the tractive effort of a vehicle is illustrated. As shown therein, the system 10 includes a first vehicle 12 configured to carry a load 14, a second wheeled vehicle 16 connected to the first wheeled vehicle 12 for selectively pushing or pulling the first wheeled vehicle 12 along a surface 18, and an apparatus 20 for increasing the tractive effort of the second wheeled vehicle 16. In an embodiment, the first wheeled vehicle 12 may be a load carrying cart and the second wheeled vehicle 16 may be a pusher or tugger unit, wherein the vehicles are configured to move along a generally planar surface. In other embodiments, the second wheeled vehicle 12 may be a locomotive or engine drive unit and the first wheeled vehicle may be a rail car or adjacent locomotive, wherein the vehicles are configured to travel along a rail. The second vehicle 16 includes a motor or other power source (not shown) configured to drive the wheels of the vehicle 16, thereby providing motive power for the vehicle 16.

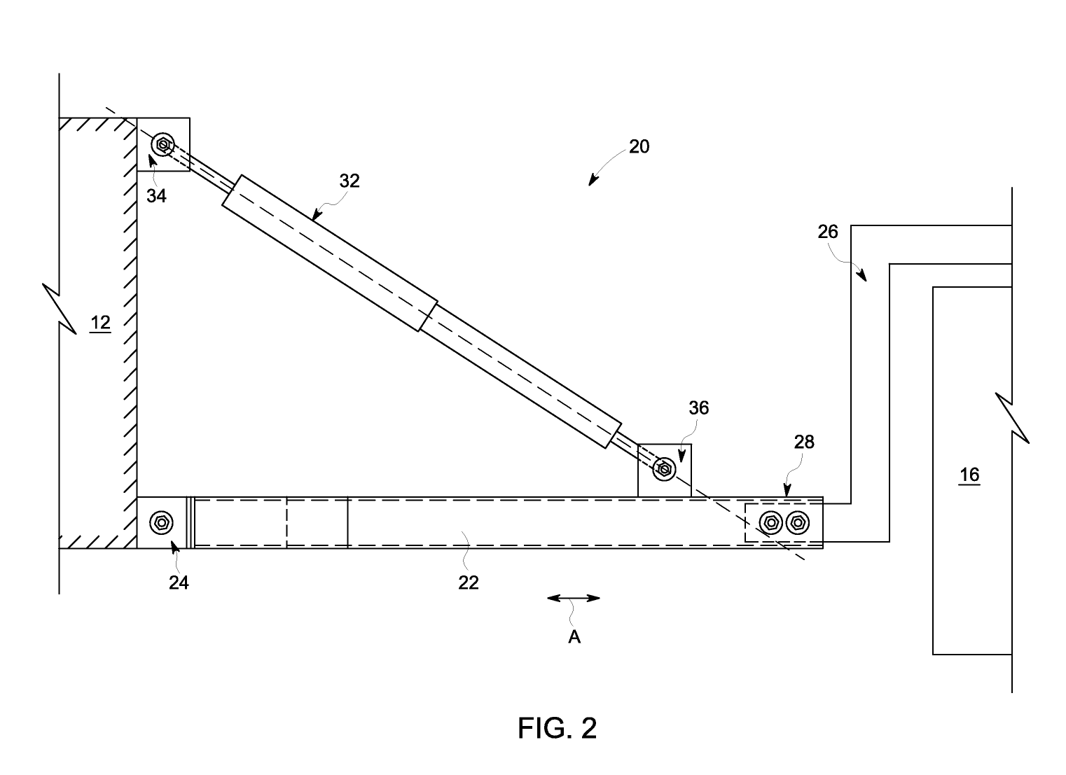

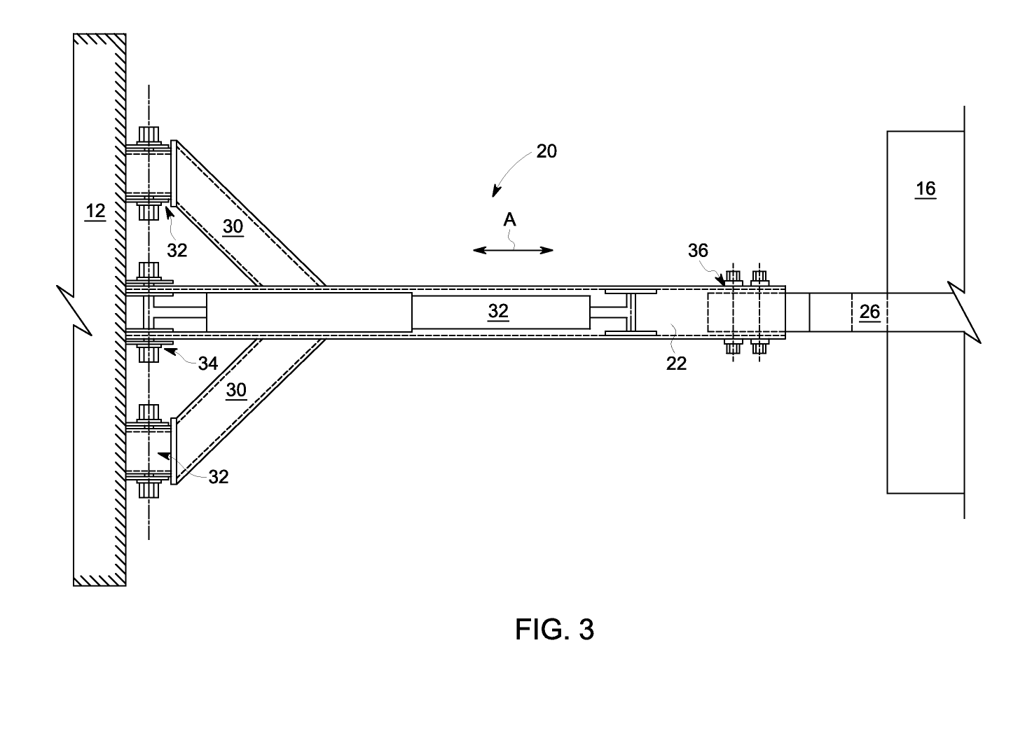

Turning now to FIGS. 2 and 3, the tractive effort apparatus 20 is illustrated in detail. As shown therein, the apparatus 20 includes a substantially rigid main linkage 22 (e.g., tow bar) that may be selectively coupled to the first vehicle 12 by a first pinned connection 24 and to an armature 26 of the second vehicle 16 by a second pinned connection 28. As used herein, “substantially rigid” shall mean rigid to a degree sufficient to transmit an axial force to the first vehicle 12 such that movement of the second vehicle 16 may be transmitted to, and effects a corresponding movement of, the first vehicle 12. In an embodiment, the second pinned connection 28 is a moment carrying connection. As best shown in FIG. 3, the main linkage 22 may include a pair of opposed supporting linkages 30 extending from the main linkage 22 and selectively coupled to the first vehicle 12 by supporting pin connections 32. The supporting linkages 30 are configured to stabilize the main linkage 22. As shown therein, the main linkage 22 and the supporting linkages 30 are oriented substantially horizontally between the first vehicle 12 and the second vehicle 16 and function to transfer a substantially horizontal pushing or pulling force, in the direction of arrow A, from the second, driving vehicle 16 to the first vehicle 12. The pinned connections may be provided by one or more bolts joining the linkages to the first vehicle and second vehicle, respectively, although other means known in the art may also be utilized.

As best shown in FIG. 2, the apparatus 20 also includes a load transferring bar 32 (also referred to herein as a jacking bar) extending at a downward angle from the first vehicle 12 towards the second vehicle 16. The jacking bar 32 is pivotally connected to the first vehicle 12 at an upper pinned connection 34 and to the main linkage 22 by a lower pinned connection 36. The jacking bar 32 is selectively extendable and retractable under manual or automatic (powered) control. In an embodiment, the jacking bar 32 may include a manually operable lead screw. In other embodiments, the jacking bar 32 may be a hydraulic or pneumatic strut.

In operation, a load 14 is placed on the first vehicle 12 and the second vehicle 16 is arranged adjacent to the first vehicle 12. The apparatus 20 is then installed between the first vehicle 12 and the second vehicle 16 to connect the vehicles to one another in the manner discussed above to enable the second vehicle 16 to push or pull the first vehicle 12 under power of the second vehicle 16. Typically, the weight of the first vehicle 12 and its load 14 will be substantially more than the weight of the second vehicle 16 which, under normal circumstances, may hinder the ability of the second vehicle 16 to push or pull the first vehicle 12 and its load 14.

With embodiments of the apparatus, however, the jacking bar 32 may be selectively extended to transfer load from the first vehicle 12 to the second vehicle 16 and to thereby increase tractive effort of the second vehicle 16. In particular, as the jacking bar 32 is extended, a compressive force is transmitted from the first vehicle 12 to the second vehicle 16 along a longitudinal axis of the jacking bar 32. As will be readily appreciated, this force includes a vertical, downward component. This downward component of force increases the normal force exerted on the surface 18 by the second vehicle 16, thereby increasing the traction force exerted by the second vehicle 16 on the surface 18. This increase in fraction force minimizes wheel slippage, loss of traction and reductions in capacity.

The apparatus 20 utilizes the jacking bar 32 (e.g., a strut or jacking screw) to selectively transfer weight from the first vehicle 12, such as a load-bearing cart, to the second, driving vehicle 16, such as a power drive unit or tugger. The driving vehicle 15 (e.g., drive unit) is essentially pushed into the ground 18 when the jacking bar 32 is extended, which increases the traction coefficient between the wheels of the driving vehicle 16 and the ground 18. By transferring weight from the object being pulled/pushed to the driving vehicle, tractive effort at the wheels of the driving vehicle is increased. This allows for an increase in capacity of the driving vehicle (e.g., tugger unit). This increase in capacity offers lower cost, increased efficiency and, therefore, cost savings. The apparatus 20 also provides stability for the driving vehicle 16. In an embodiment, the apparatus 20 may be retrofit onto existing vehicles that are ordinarily too small or do not have enough mass to take full advantage of their drive capability (i.e., they have trouble transferring horsepower from the drive to the ground due to a lack of weight).

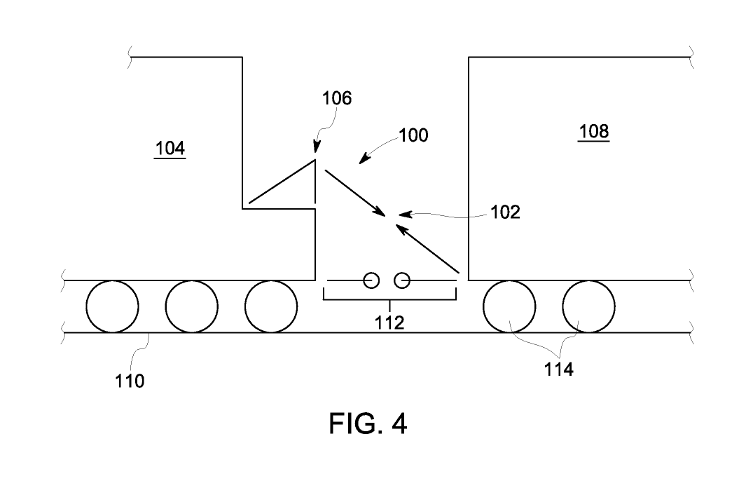

Turning now to FIG. 4, an apparatus 100 for increasing the tractive effort of a vehicle according to another embodiment of the present invention is illustrated. The apparatus 100 includes a load transferring bar 102 (e.g., a tension/compression strut) having a first end mounted to a first vehicle 104 via a frame 106 and a second end mounted to a second vehicle 108. As illustrated, the first vehicle 104 may be a train car or adjacent locomotive, and the second vehicle 108 may be a locomotive or other engine drive unit configured to travel over a rail 110. In an embodiment, the frame 106 is mounted to the platform of the first, trail vehicle 104. In other embodiments, the bar 102 (e.g., strut) may be directly coupled to the platform, chassis, or other component of the vehicle 104 (in which case the frame 106 may be omitted). In any manner of implementation, the bar 102 extends at a downward angle from the vehicle from which weight is to be transferred to the vehicle to which the weight is to be transferred. In an embodiment, more than one load transferring bar may be utilized, e.g., the apparatus may include plural struts. In an embodiment, the strut(s) or other load transferring bars 102 may be coupled to the first and second vehicles 104, 108 by pinned connections that allow for some rotation about the pins, although other means of connection known in the art may also be utilized without departing from the broader aspects of the present invention. The vehicles 104, 108 may be coupled to one another by rail vehicle couplers or other linkage 112, as illustrated, for transferring forces between the vehicles to allow for pulling. Accordingly, in an embodiment, linkage 112 may function similar to linkage 22, as described above.

In operation, in order to promote traction on a single truck of a locomotive, weight from an adjacent locomotive or car can be transferred through the apparatus 100 to a single truck. As discussed, above, the purpose of the weight transfer is to promote larger amounts of traction and, therefore, horsepower application, if needed. In particular, by adding a series of struts to support a compression or tension link between a drive locomotive (e.g., vehicle 108) and an adjacent locomotive or an adjacent car (e.g., vehicle 104), weight can be transferred to the dominant drive locomotive platform and therefore to the trucks of the drive locomotive. The struts do not interfere with the existing link 112 used between cars in the rail industry. As will be readily appreciated, the apparatus of the present invention therefore allows for a more efficient application of horsepower through increased friction between the track 110 and the drive wheels 114 of the driving vehicle 108. By increasing traction on the rail, fuel and cost savings may be realized.

In an embodiment, a system includes a first vehicle, a second vehicle, and a load transferring apparatus intermediate the first vehicle and the second vehicle. The apparatus includes a substantially rigid linkage connecting the first vehicle to second vehicle which is configured to transmit a generally horizontal force between the first vehicle and the second vehicle, and a load transferring bar extending at a downward angle from the first vehicle to one of the second vehicle or the linkage. The load transferring bar is configured to selectively transfer weight from the first vehicle to the second vehicle. In an embodiment, the load transferring bar is selectively extendable and retractable, wherein in an extended position the bar transfers weight from the first vehicle to the second vehicle. In an embodiment, the load transferring bar is manually extendable and retractable. In an embodiment, the load transferring bar is extendable and retractable under control of a control unit. In an embodiment, the load transferring bar comprises a hydraulic strut. In an embodiment, the load transferring bar comprises a pneumatic strut. In an embodiment, the first vehicle may be a wheeled cart and the second vehicle may be a tugger unit. In an embodiment, the first vehicle may be a rail car, the second vehicle may be an engine-powered locomotive, where first vehicle and the second vehicle are configured for travel along a rail. In an embodiment, the load transferring bar is attached to the first vehicle and the one of the second vehicle and the linkage via pinned connections.

In another embodiment, an apparatus includes a substantially rigid linkage configured for coupling a first vehicle to a second vehicle, the linkage also being configured to transmit a generally horizontal force between the first vehicle and the second vehicle, and at least one load transferring bar configured for selective coupling with the first vehicle and one of the second vehicle or the linkage. The at least one load transferring bar is further configured, when coupled to the first vehicle and said one of the second vehicle or the linkage, to extend at a downward angle from the first vehicle to said one of the second vehicle or the linkage and to selectively transfer weight from the first vehicle to the second vehicle. In an embodiment, the at least one load transferring bar is selectively extendable to transfer weight from the first vehicle to the second vehicle. In an embodiment, the at least one load transferring bar is manually extendable and retractable. In an embodiment, the at least one load transferring bar is automatically extendable and retractable under control of a control unit. In an embodiment, the at least one load transferring bar comprises a hydraulic strut. In another embodiment, the at least one load transferring bar comprises a pneumatic strut. In other embodiments, the at least one load transferring bar comprises a plurality of struts. In an embodiment, the apparatus may also include a frame member connected to the first end of the load transferring bar. The frame member is configured for attachment to the first vehicle and provides a first connection point of the load transferring bar to the first vehicle that is at a height from a surface on which the vehicle travels that is greater than a height of a second connection point of the load transferring bar to the second vehicle. In an embodiment, the first vehicle is a rail car, the second vehicle is an engine-powered locomotive, and the first vehicle and the second vehicle are configured for travel along a rail.

In yet another embodiment, a method includes the steps of arranging a first vehicle adjacent to a second vehicle, the first vehicle and second vehicle being configured to travel along a surface, and coupling a first end of an extendable load transferring bar to the first vehicle at a first point, the first point defining a first height above the surface. The method further includes coupling a second end of the load transferring bar to the second vehicle at a second point (the second point defining a second height above the surface, and the first height being greater than the second height), and extending the load transferring bar to transfer weight from the first vehicle to the second vehicle. In an embodiment, the method may also include the step of connecting a substantially rigid, horizontal linkage between the first vehicle and the second vehicle. In an embodiment, the surface may be a rail, the first vehicle may be a rail car, and the second vehicle may be an engine-powered locomotive. In an embodiment, the first vehicle may be a wheeled cart and the second vehicle may be a tugger unit.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The terms “including” and “in which” are used as the plain-English equivalents of the respective terms “comprising” and “wherein.” Moreover, the terms “first,” “second,” “third,” “upper,” “lower,” “bottom,” “top,” etc. are used merely as labels, and are not intended to impose numerical or positional requirements on their objects.

This written description uses examples to disclose several embodiments of the invention, including the best mode, and also to enable one of ordinary skill in the art to practice the embodiments of invention, including making and using any devices or systems and performing any incorporated methods.

As used herein, an element or step recited in the singular and proceeded with the word “a” or “an” should be understood as not excluding plural of the elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the embodiments described herein, it is intended that all of the subject matter of the above description or shown in the accompanying drawings shall be interpreted merely as examples illustrating the inventive concept herein and shall not be construed as limiting the invention.

1. A system, comprising:
a first vehicle;
a second vehicle; and
a load transferring apparatus intermediate the first vehicle and the second vehicle, the apparatus including a substantially rigid, unitary linkage connecting the first vehicle to the second vehicle and configured to transmit a generally horizontal pulling and pushing force between the first vehicle and the second vehicle, and a load transferring bar extending at a downward angle from the first vehicle to one of the second vehicle or the linkage and configured to selectively transfer weight from the first vehicle to the second vehicle.

2. The system of claim 1, wherein:
the load transferring bar is selectively extendable and retractable;
wherein in an extended position the bar transfers weight from the first vehicle to the second vehicle.

3. The system of claim 2, wherein:
the load transferring bar is manually extendable and retractable.

4. The system of claim 2, wherein:
the load transferring bar is extendable and retractable under control of a control unit.

5. The system of claim 4, wherein:
the load transferring bar comprises a hydraulic strut.

6. The system of claim 4, wherein:
the load transferring bar comprises a pneumatic strut.

7. The system of claim 1, wherein:
the first vehicle is a wheeled cart; and
the second vehicle is a tugger unit.

8. The system of claim 1, wherein:
the first vehicle is a rail car;
the second vehicle is an engine-powered locomotive; and
the first vehicle and the second vehicle are configured for travel along a rail.

9. The system of claim 1, wherein:
the load transferring bar is attached to the first vehicle and the one of the second vehicle or the linkage via pinned connections.

10. An apparatus, comprising:
a substantially rigid, unitary linkage configured for coupling a first vehicle to a second vehicle, the linkage also being configured to transmit a generally horizontal pulling and pushing force between the first vehicle and the second vehicle; and
at least one load transferring bar configured for selective coupling with the first vehicle and one of the second vehicle or the linkage, wherein the at least one load transferring bar is further configured, when coupled to the first vehicle and said one of the second vehicle or the linkage, to extend at a downward angle from the first vehicle to said one of the second vehicle or the linkage and to selectively transfer weight from the first vehicle to the second vehicle.

11. The apparatus of claim 10, wherein:
the at least one load transferring bar is selectively extendable to transfer weight from the first vehicle to the second vehicle.

12. The apparatus of claim 11, wherein:
the at least one load transferring bar is manually extendable and retractable.

13. The apparatus of claim 11, wherein:
the at least one load transferring bar is automatically extendable and retractable under control of a control unit.

14. The apparatus of claim 10, wherein:
the at least one load transferring bar comprises a hydraulic strut.

15. The apparatus of claim 10, wherein:
the at least one load transferring bar comprises a pneumatic strut.

16. The apparatus of claim 10, wherein:
the at least one load transferring bar comprises a plurality of struts.

17. The apparatus of claim 10, further comprising:
a frame member connected to a first end of the load transferring bar, the frame member being configured for attachment to the first vehicle;
wherein the frame member provides a first connection point of the load transferring bar to the first vehicle that is at a height from a surface on which the first vehicle travels that is greater than a height of a second connection point of the load transferring bar to the second vehicle.

18. The apparatus of claim 10, wherein:
the first vehicle is a rail car;
the second vehicle is an engine-powered locomotive; and
the first vehicle and the second vehicle are configured for travel along a rail.

19. The system of claim 7, wherein:
the first vehicle is configured to resist rotation about a wheel axis of the first vehicle.
